(19) United States
(12) Patent Application Publication
(10) Pub. No.: US 2005/0284871 A1
(43) Pub. Date: Dec. 29, 2005

(54) Plastic accessory-holder flange for hollow thermoplastic body

(76) Inventors: Stephane Leonard, Brussels (BE); Bjorn Criel, Merelbeke (BE)

Correspondence Address: CONNOLLY BOVE LODGE & HUTZ, LLP, P O BOX 2207, WILMINGTON, DE, 19899, US

(21) Appl. No.: 10/530,237

(22) PCT Filed: Oct. 3, 2003
(86) PCT No.: PCT/EP03/11067

§ 371 Date: Apr. 11, 2005

(30) Foreign Application Priority Data
Oct. 4, 2002 (FR) 0212492

(51) Int. Cl. B60P 3/00

(52) U.S. Cl. 220/562

(57) ABSTRACT

Injection-moulded plastic flange for mounting accessories, in order to close off an opening in a hollow thermoplastic body, which flange has a thread on its periphery. Process for manufacturing a fuel tank comprising such a threaded flange on which at least one accessory is mounted by placing a compressible seal around the periphery of the flange, by making the flange and the seal bear on the perimeter of the opening in a shell, by screwing a ring onto the thread of the flange and by welding the shell to at least one other shell in order to obtain a tank.

The present invention relates to a plastic flange for mounting accessories, this being intended to be fitted onto a thermoplastic hollow body.

The problem posed by fixing accessories onto hollow bodies, in particular when these accessories communicate with the outside of the tank, has been solved by various devices while ensuring that the hollow body is sealed with respect to the atmosphere with greater or lesser effectiveness.

For example U.S. Pat. No. 6,227,242-B1 discloses an injection-moulded fuel tank flange on which a pressure-limiting safety valve is mounted. Passing through the flange is a line for fuel to return to the tank. In that document, the method of holding the flange in place on the tank is not specified.

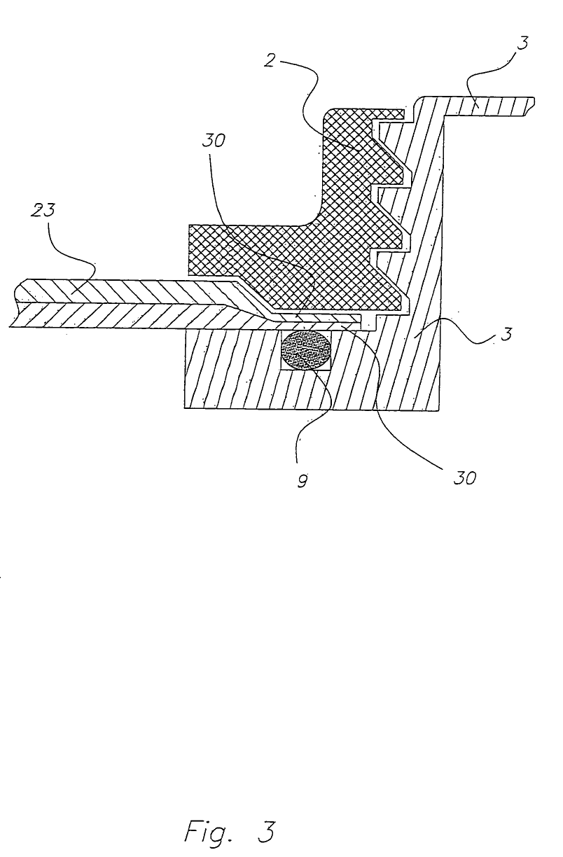

In addition, Patent Application DE-42 40 629-A1 discloses a device for fixing an accessory onto a plastic fuel tank obtained by blow moulding. A threaded metal ring (FIG. 3, item 11) is placed around the periphery of a flange (2) placed on a seal (3′) carried by a rim (3) over the opening in the tank (1) and an injection-moulded plastic ring (14) is screwed onto the thread (13) of the metal ring (11) and holds the flange (2) in place clamped onto the seal (3′).

The device of Document DE-42 40 629-A1 has the disadvantage of requiring an additional part in the form of a ring. The fact that this ring is made of a very rigid material induces weaknesses into the impact behaviour of the tank, owing to the local rigidification that it causes in the wall of the latter near the opening.

The object of the invention is to provide a plastic flange for mounting accessories that does not have the drawbacks of the known systems, in particular a flange that introduces no exaggerated rigidification of the walls of the tank and is easy and inexpensive to produce.

Moreover, the aim of the invention is also to provide a flange that exhibits excellent dimensional stability, generally superior to that obtained by blow moulding techniques.

For this purpose, the invention relates to an injection-moulded plastic flange for mounting accessories on a thermoplastic hollow body, capable of closing off, in a sealed manner, an opening cut into the wall of this hollow body, characterized in that the said flange has a thread on its periphery.

The accessory-mounting flange according to the invention is a flattened part intended to close off an opening of a hollow body and/or to support any type of accessory mounted on the wall of such a hollow body. The flange is in particular well suited to supporting accessories that pass through the wall of the hollow body. It has a perimeter closed on itself, of any shape. Usually its perimeter has a circular shape.

The flange according to the invention is made of a plastic. Any type of plastic may be suitable. It is preferable to choose a plastic whose dimensional stability is good in an environment subjected to temperature variations of the order of several tens of degrees Celsius.

It is also preferable to choose a plastic whose dimensional stability is little affected by contact with the liquids and gases liable to be contained in the tank.

The term “plastic” is understood to mean any material comprising at least one synthetic polymer resin. The term “polymer” is understood to mean both homopolymers and copolymers (especially binary or ternary copolymers). Examples of such copolymers are, without being limited thereby, random copolymers, linear block or other block copolymers and graft copolymers.

All types of plastic may be suitable. Very suitable plastics belong to the category of thermoplastics or the category of plastics that remain rigid when heated (thermosets). Preferably, the plastic is a thermoplastic.

The term “thermoplastic” is understood to mean any thermoplastic polymer, including thermoplastic elastomers, and also blends thereof.

Any type of thermoplastic polymer or copolymer whose melting point is below the decomposition temperature is suitable. Synthetic thermoplastics having a melting range spread over at least 10 degrees Celsius are particularly suitable. Examples of such materials are those exhibiting polydispersion in their molecular weight.

In particular, it is possible to use polyolefins, polyvinyl halides, thermoplastic polyesters, polyketones, polyamides and copolymers thereof.

Plastics that remain rigid when subjected to heat may belong, for example, to resins obtained by a polyaddition, polycondensation or crosslinking reaction when subjected to heat or radiation, or else by a vulcanizing reaction.

A blend of thermoplastic polymers, a blend of thermosets or a blend of at least one thermoplastic polymer with at least one thermoset may also be used, as may a blend of polymeric materials with inorganic, organic and/or natural fillers such as, for example, but not to be limited thereby; carbon, salts and other inorganic derivatives, natural fibres or polymer fibres. It is also possible to use multilayer structures consisting of stacked layers bonded together, comprising at least one of the polymers, copolymers or thermosets described above.

According to the invention, the flange is made of an injection-moulded plastic, that is to say one that has been formed by an injection-moulding technique in which the material is injected under pressure into a mould.

The flange according to the invention is intended for a thermoplastic hollow body.

The term “hollow body” is understood to mean any structure whose surface has at least one empty or concave portion. Preferably, the hollow body to which the invention applies is a shell constituting all or part of a tank intended to contain at least one liquid and/or gas.

The term “thermoplastic” has the same meaning in the case of the hollow body as that explained above as one possible nature of the plastic of the flange.

According to the invention, the flange is capable of closing off, in a sealed manner, an opening cut into the wall of the hollow body.

The term “sealed closure” is understood to mean the ability to prevent communication via the closed-off opening of liquid and/or gas in contact with the empty or concave portion of the hollow body with the other side, under temperature and pressure conditions of normal use of the hollow body.

The wall of the hollow body to which the flange is intended may consist of a single layer of thermoplastic or of two layers. One or more other possible additional layers may advantageously consist of layers made of a material that is a barrier to liquids and/or gases. Preferably, the nature and the thickness of the barrier layer are chosen so as to reduce as far as possible the permeability of the liquids and gases in contact with the concave surface of the hollow body.

The wall of the hollow body may have been produced by moulding using various well-known techniques. Among such techniques, mention may be made, for example, of blow moulding and compression moulding.

The wall of the hollow body may or may not be closed on itself, that is to say may or may not define an internal space. When the wall is not closed, the hollow body is in the form of a shell that may form a portion of a tank. When the wall of the hollow body is closed, it coincides with that of a tank.

In the expressions “internal surface” and “internal direction”, the term “internal” refers to that portion of the shell oriented towards the internal space of the tank and in the expressions “external surface” and “external direction”, the term “external” refers to that portion of the shell oriented towards the external space of the tank.

According to the invention, the flange has a thread on its periphery. The term “thread” is understood to mean a helical thread capable of cooperating with another thread on an assembling or tightening member intended to hold the flange in place over the opening of the hollow body and to ensure sealing.

The thread on the flange may have been obtained in various ways. For example, it may have been produced at the same time as the flange, during injection moulding of the latter. It may also have been produced after the flange has been injection-moulded, by mechanical machining using a tool. Preferably, the thread on the flange is injection-moulded at the same time as the flange.

That portion of the flange bearing the thread is generally capable of passing through the opening in the hollow body. The threaded portion of this flange may extend, completely or partly, to the outside of the hollow body, on the convex side of its surface, or alternatively on the internal, concave side.

According to one advantageous embodiment of the flange, the impermeability to liquids and gases is provided by the interposition of a compressible seal between this flange and that wall of the hollow body which is located near the opening. The seal used may be in various forms. For example, it may be a toroidal seal. A toroidal seal of circular section, or O-ring, has given good results.

The compressible seal is generally made of an elastomeric plastic or a rubber. Preferably, the material chosen for the seal is a material that is inert with respect to liquids and gases in contact with the concave surface of the hollow body.

The seal may simply be placed around the perimeter of that surface of the flange which is plumb with the opening in the wall of the hollow body. Preferably, it is inserted into a groove cut out around the perimeter of the surface of the flange.

Various types of assembling member may be used to hold the flange in place over the opening of the hollow body.

A member usually employed for this purpose is a threaded ring which cooperates with the thread on the flange.

This ring may be made of various materials, such as metal, thermoset or thermoplastic. Preferably, the ring is also an injection-moulded plastic part.

Advantageously, the ring may have, on the side facing the wall of the tank, a shoulder intended to bear on this wall. This arrangement of the ring sets the maximum clamping pressure of the ring on the thread of the flange, when it is screwed up until its shoulder abuts the wall of the tank. This thus avoids any damage to the flange due to overtightening.

When a compressible seal is interposed between the flange and the wall of the hollow body, it is also possible, advantageously, to hold the seal in the compressed state by tightly screwing the ring onto the thread of the flange.

It is preferable to choose for the flange a plastic whose permeability to gases and liquids is low, in particular to those that are intended to be in contact with the concave surface of the hollow body. Examples of such liquids or gases are hydrocarbons and alcohols. “Low permeability” of the plastic is understood to mean a fuel-specific permeability not exceeding 5 g.mm/day.m² at 40° C.

As examples of plastics with low permeability to liquids and gases, mention may be made, without being limited thereby, of the following: polyacetals, polyamides, polyesters, polyvinylidene halides, liquid-crystal polymers, polyketones and polyphenylene sulphides. It is also possible to use binary or ternary copolymers of these plastics.

Plastics that have given good results are the following:
polyoxymethylenes, such as the polymers HOSTAFORM® RFV and ERITAL®;
nylon-6 polyamides, such as the polymer GRILON® PVZ-3H;
nylon-6,6 polyamides, such as the polymer ULTRAMID® A3WG6;
nylon-6,6 copolyamides, such as the polymers ZYTEL® HTN51 and G35HSL;
polybutylene terephthalates, such as the polymer VALOX® 830;
polyvinylidene fluorides, such as the polymers SOLEF® 1008 and SOLEF® 8008;
liquid-crystal polymers, such as the polymer VECTRA® 950;
polyketones, such as the polymer CARILON® DPR1130; and
polyphenylene sulphides, such as the polymer PRIMEFS 4010.

One particular embodiment of the flange according to the invention is that for which the hollow body is a fuel tank. More particularly, the fuel tank is a tank for a motor vehicle. The term “motor vehicle” is understood to mean vehicles driven by a combustion engine, such as lorries, cars and motor cycles.

In this particular embodiment, at least one accessory of a fuel tank may advantageously be mounted on the flange. The term “mounted” is understood here to mean that the accessory is fastened or assembled by a fixing and holding means. Various types of these means may be present on the flange according to the invention. For example, there may be welding means and purely mechanical fixing means, such as bolting, screwing, riveting or clip-fastening. Alternatively, it is also possible for at least one accessory to be fastened to the flange by joint manufacture of the latter at the same time as the accessory by means of the injection-moulding technique.

The term “accessory” is understood to denote in general any member through which liquid or gas passes, or one which is in contact with liquid or gas, and which fulfils a particular function specific to a device forming part of the tank, including the function of transporting liquid and/or gas between two other members.

In this embodiment, the flange according to the invention is particularly well suited for mounting at least one accessory chosen from a fuel pump module, a volume gauge, a pipette connected to a line for the inflow or outflow of liquid and/or gaseous fuel, a connector and an electrical cable.

It is also beneficial, in this embodiment, for the flange to be intended for a fuel tank consisting of at least two shells made of a multilayer thermoplastic, the shells being welded together.

The invention also relates to a fuel tank for a motor vehicle, which comprises at least one accessory mounted on an accessory-mounting flange in accordance with the flange mentioned above.

The term “accessory” here has the same meaning as that given earlier in the case of the flange.

Finally, the invention also relates to a process for manufacturing a fuel tank that includes a flange according to the invention for mounting at least one accessory, in which process the following steps are carried out, in the order indicated:
a) a seal is placed in a groove cut out around the periphery of the flange and facing the wall of a shell, around the perimeter of an opening cut into the latter;
b) the flange is positioned over the opening, so that the seal bears all around the perimeter of the opening and so that the opening passes through the threaded part of the flange;
c) a ring is screwed onto the threaded part until abutment, against the outer wall of the shell, of the surface of the flange hugging the groove; and
d) the shell bearing the flange is welded to at least one other shell so as to obtain a tank.

In this process, the flange is positioned over the opening, either from the internal surface or from the external surface of the shell, so that the seal bears around the entire perimeter of the opening and so as to make the opening pass through the threaded portion of the flange oriented either in the external-to-internal direction of the shell, or, preferably, in the internal-to-external direction of the shell.

In this process, the terms “tank”, “flange”, “fuel”, “mount”, “accessory”, “shell”, and “thread” have exactly the same meanings as those mentioned above in the case of the accessory-mounting flange.

The accessory may have been fastened to the flange in a prior operation. It may also form an integral part of the flange and may have been manufactured at the same time as the latter. As a variant, the accessory may also be fastened to the flange immediately before the process according to the invention is carried out.

The shells may be welded together using any suitable technique well known for obtaining tanks. Welding shells using a technique called hot-plate or mirror welding has given good results.

It is preferred to choose the smallest possible size of flange compatible with the space required for the electrical connectors and/or the connections for passage of the fuel and/or venting lines.

When it is necessary to mount one or more bulky accessories on the flange, the span of which exceeds the largest diameter of the flange and of the opening in the shell, they are put in place, with the flange, via the concave internal side of the flange.

The degree of compression of the seal may advantageously be adjusted by tightening to the point when the peripheral region of the flange butts against the concave internal wall of the tank. This offers the advantage of mechanically preserving the seal and extending its lifetime. The surface finish and the thickness of the wall of the tank may be set by compression moulding, or alternatively, they may also be set by machining.

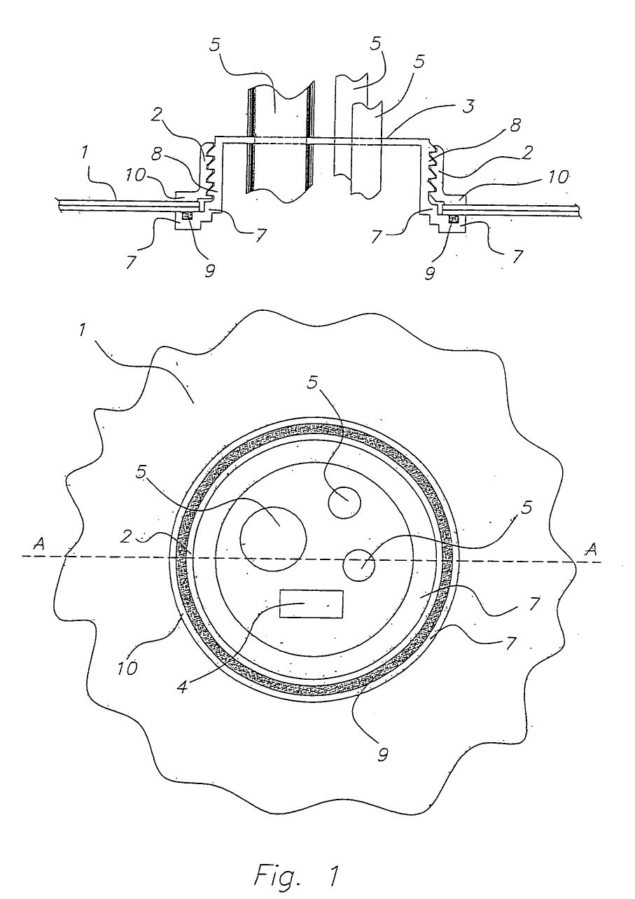

FIG. 1 which follows is given in order to illustrate the invention, without intending to restrict the scope thereof.

FIG. 1 shows a diagram in sectional view and in side view of a flange (3) for closing off an opening in a fuel tank (1). The monolayer flange (3) was produced by injection-moulding a polyacetyl (a polyoxymethylene of the ERITAL® brand), bearing a thread (8) obtained directly by injection moulding. The tank (1) was a multilayer tank comprising, from the outside inwards, an external layer of HDPE (high-density polyethylene) of the ELTEX® RSB714 N0060 brand, a layer of a plastic coming from the recycling of ground scrap coming from the same tanks, a layer of adhesive (ADMER® L2100, a barrier layer made of an ethylene-vinyl-alcohol copolymer of the EVAL® F101A brand, another layer of adhesive ADMER® L2100 and an internal HDPE layer of ELTEX® RSB714 N0060.

A groove (6) has been cut around the periphery (7) of the flange (3) and contains an O-ring seal (9) made of a fluoroelastomer of the FKM vinylidene fluoride/hexafluoropropylene type of the Hutchinson-Le Joint Francais DF801 brand, which was pressed against the concave internal surface of the wall of the tank (1), near the opening. A circular ring (2) threaded on its internal face was screwed onto the thread (8) of the flange (3) in order to hold it in place assembled with the tank and to keep the seal (9) in compression. The ring (2) had been produced beforehand by cutting and machining of a disc from a bar of POM of ERITAL® brand, so as to simulate the dimensional precision of an injection-moulded POM ring. A shoulder (10) on the ring (2) came to bear on the external surface of the tank (1), around the perimeter of the opening.

The degree of compression of the seal (9) was set by the tightening so that the peripheral region (7) of the flange (3) butts against the concave internal wall of the tank (1). The surface finish and the thickness of the wall of the tank (1) near the opening were set by compression moulding. Alternatively, the surface finish and the thickness were also successfully defined by machining instead of by compression moulding.

An electrical connector (4) and through-connectors (5) for the fuel inflow, outflow and venting lines were also injection-moulded as one piece and at the same time as the flange, made from the same POM as the latter.

### EXAMPLES

### Example 1

### “Mini-Flange” MF1, According to the Invention

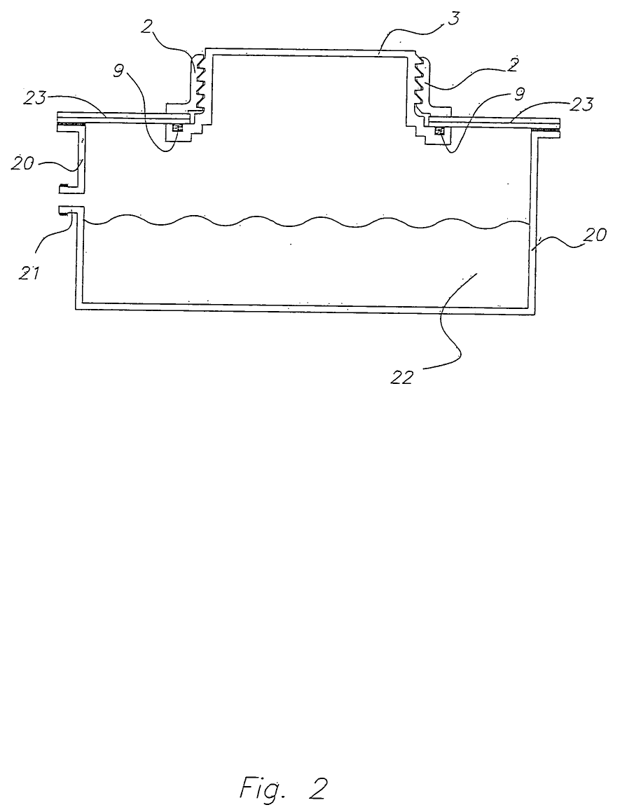

A flange (3) similar to that of FIG. 1, except that no accessory was mounted on it, was used and this is illustrated in FIG. 2. It was joined to a plate (23) cut into a multilayer fuel tank similar to that described in FIG. 1, and provided with an orifice 73 mm in diameter and held in place by a circular ring (2) and a seal (9), these being similar to those described in FIG. 1. The assembly, comprising plate (23), flange (3), ring (2) and seal (9), was placed on a steel cell (20) provided with a liquid inlet line (21) and its volume half-filled with a mixture (22) comprising 90% by volume of petrol of the HALTERMANN® RF02-99 brand and 10% of an analytical grade ethanol. A fluoropolymer seal of the same nature as the seal (9) was interposed between the plate (23) and the cell (20) which are held joined together by bolts.

The test consisted in closing the inlet line (21) of the cell (20) half-filled with the petrol/ethanol fuel mixture (22) and in turning the cell upside down so that the liquid fuel comes into direct contact with the plate (3). After the assembly was conditioned at 40° C. for 288 hours, the permeability of the plate (23)/flange (3)/ring (2)/seal (9) assembly acting as specimen was measured using a procedure called the “Mini-Shed” procedure.

This procedure consisted in placing the specimen in a sealed chamber conditioned at 40° C. and connected to a system for measuring the hydrocarbon concentration. By measuring the increase in this hydrocarbon concentration in the chamber over the course of time it was possible to determine the amount of vapour emitted by the specimen.

### Example 2

### “Mini-Flange” MF2, According to the Invention

Example 1 was repeated with another “Mini-Flange” specimen MF2 similar to the specimen of Example 1, except that the shape of the cross section of the plate (23) in line with the seal (9) was thinned, as illustrated at 30 (see FIG. 3).

Control Examples (not According to the Invention)

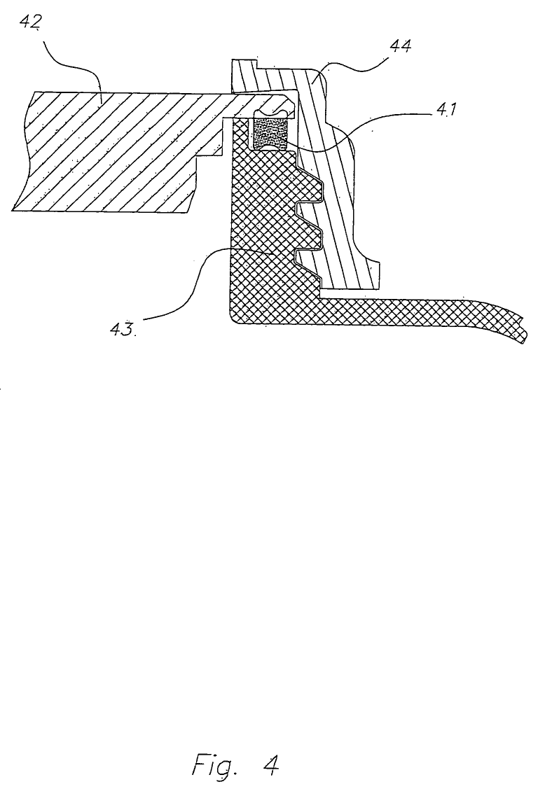

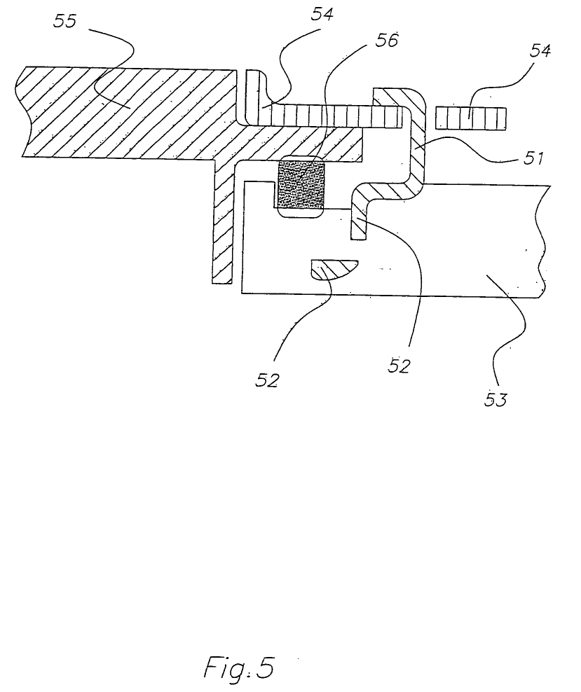

Four specimens of commercial flanges not according to the invention, illustrated schematically in FIGS. 4 and 5, known as Mason Jar 1 and 2 (MJ1 and MJ2) and Camlock 1 and 2 (CL1 and CL2), were used as controls.

In the case of specimens MJ1 and MJ2, FIG. 4 shows the presence of a H-shaped seal (41) inserted between the flange (42) and the threaded socket of the tank (43). This figure also shows a ring (44) holding the assembly consisting of the flange (42) and the tank (43) together by compression of the seal (41).

In the case of specimens CL1 and CL2, FIG. 5 illustrates a bayonet-type closure system comprising a metal pin (51) having its base (52) anchored in the bulk of the wall (53) of a multilayer tank, which cooperates with another, ring-shaped metal part serving to keep a flange (55) in place on the socket of the tank (53), compressing a seal (56).

For all the specimens MJ1, MJ2, CL1 and CL2, the flanges (42) and (55) were formed by steel plates. The opening diameters of the multilayer tank plates were the following:
MJ1: 113.75 mm
MJ2: 139 mm
CL1: 138 mm
CL2: 113.75 mm.

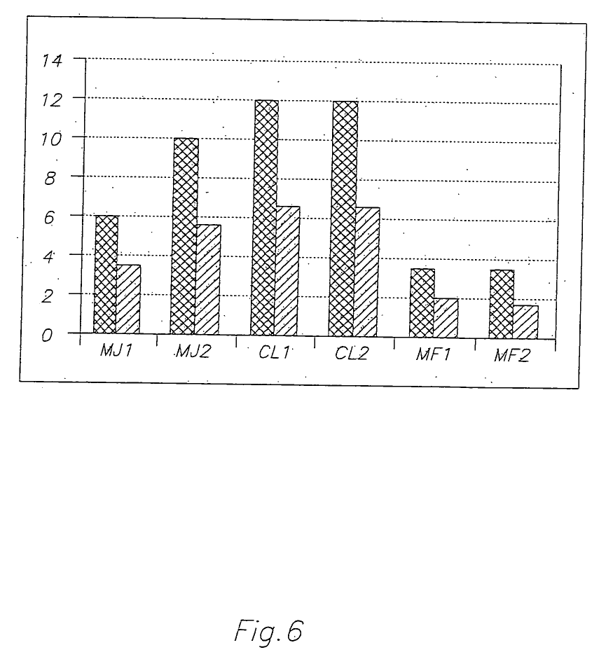

FIG. 6 summarizes the results obtained from the permeability measurements by a bar chart giving, for each specimen, the measured permeability after 12 weeks of conditioning at 40° C., expressed each time in mg of fuel/day at 40° C. (left-hand bar) and in mg of fuel (right-hand bar). The unit mg of fuel corresponds to the evaporative loss obtained for a standardized temperature cycle (18.3-40.6-18.3° C.) of 24 hours duration.

1. An injection-moulded plastic flange for mounting accessories on a thermoplastic hollow body, capable of closing off, in a sealed manner, an opening cut into the wall of this hollow body, the said flange having a thread on its periphery.

2. The flange according to claim 1, which is capable of receiving a ring for holding its assembly with the hollow body in place.

3. The flange according to claim 1, wherein the plastic used to make it has a low permeability to gases and liquids.

4. The flange according to claim 1, wherein the plastic is selected from the group consisting of polyacetals, polyamides, polyesters and polyvinylidene halides.

5. The flange according to claim 1, wherein the hollow body is a fuel tank for a motor vehicle.

6. The flange according to claim 1, which has mounted on it at least one accessory of a fuel tank, selected from the group consisting of a pump module, a volume gauge, a pipette connected to a line for the inflow or outflow of liquid and/or gaseous fuel, a connector and an electrical cable.

7. The flange according to claim 5, wherein the fuel tank consists of at least two shells made of a multilayer thermoplastic, the shells being welded to one another.

8. A fuel tank for a motor vehicle, which has at least one accessory mounted on an accessory-mounting flange according to claim 5.

9. The tank according to claim 8, wherein the impermeability to gases and liquids is provided by the interposition of a compressible seal between the flange and that wall of the tank which is located near the opening, it being possible for the seal to be held in the compressed state by tightly screwing the ring onto the thread of the flange.

10. A process for manufacturing a fuel tank that includes a flange according to claim 7 for mounting at least one accessory, wherein the following steps are carried out, in the order indicated:
a) a seal is placed in a groove cut out around the periphery of the flange and facing the wall of a shell, around the perimeter of an opening cut into the latter;
b) the flange is positioned over the opening, so that the seal bears all around the perimeter of the opening and so that the opening passes through the threaded part of the flange;
c) a ring is screwed onto the threaded part until abutment, against the outer wall of the shell, of the surface of the flange hugging the groove; and
d) the shell bearing the flange is welded to at least one other shell so as to obtain a tank.
